(19) United States
(12) Patent Application Publication
(10) Pub. No.: US 2019/0330418 A1
(43) Pub. Date: Oct. 31, 2019

(54) An Improved Urethane Alkyd Resin

(71) Applicant: Asian Paints LTD, Munbai (IN)

(72) Inventors: Rajeev K Jain, Navi Mumbai (IN); Devchandra Pandit, Navi Mumbai (IN); Ganesh Bathiri, Navi Mumbai (IN); Sagar Pangam, Navi Mumbai (IN); Satishchandra Shetty, Navi Mumbai (IN); Rajeev K. Goel, Navi Mumbai (IN)

(21) Appl. No.: 16/473,243

(22) PCT Filed: Nov. 20, 2018
(86) PCT No.: PCT/IN2018/050766

§ 371 Date: Jun. 24, 2019

(30) Foreign Application Priority Data
Nov. 27, 2017 (IN) 201721042425

(51) Int. Cl. C08G 63/48; C09D 167/08; C09D 7/63; C09D 7/61; C08G 63/685; C08G 63/695; C08G 63/91

(52) U.S. Cl. CPC C08G 63/48; C09D 167/08; C09D 7/63; C08G 63/91; C08G 63/685; C08G 63/695; C09D 7/61

(57) ABSTRACT

The present invention relates to the formulation and process of preparing a functionalized urethane alkyd resin. More particularly, the invention relates to a siliconized urethane alkyd resin obtained from an alkyd based on semi drying/drying Oils or their fatty acids having high iodine number of 120-170 (gm I₂/100 gm) followed by grafting of epoxy alkyl alkoxy silane or silanol functional silicone resin into the alkyd backbone and subsequent urethanization of the organosilane grafted alkyd. Siliconized urethane alkyd thus obtained were incorporated in solvent borne pigmented coating compositions and found suitable for preparing air drying 1 pack coatings providing excellent corrosion resistance, weathering and mechanical properties when applied on variety of substrates such as mild steel, corroded mild steel, other metals, alloys, glass, wood and cementitious etc.

### FIELD OF THE INVENTION

Present invention relates to the formulation and process of silicone functionalized urethane alkyds obtained from alkyds based on semi drying/drying oil or their fatty acids having Iodine Number of 120-170 (gm I₂/100 gm) with linolenic acid content preferably <10% but not limited to and subsequent reaction of residual carboxylic and hydroxyl groups present in such alkyd with epoxide functional alkoxy silane and/or with silanol functional silicone resins which are further reacted with aliphatic/cycloaliphatic/aromatic polyisocyanates or their derivatives to create urethane linkages. In another aspect of the present invention this entire reaction of preparing base alkyd followed by grafting epoxy alkyl alkoxy silane and/or silanol functional silicone resin and subsequent urethanization has been carried out in-situ.

In an embodiment of the present invention, such grafting of epoxy alkyl alkoxy silane/silicone resin into alkyd back bone followed by urethane resulted into outstanding corrosion resistance and weathering performance. In the light of these findings such silicone functionalized alkyds have been found suitable for preparing air drying single component coating compositions for new as well as corroded mild steel and other metallic/nonmetallic substrates when incorporated in solvent borne pigmented coating compositions. The single pack coating compositions prepared from siliconized urethane alkyd provide superior corrosion resistance, weathering and mechanical properties over conventional alkyds or urethane alkyds free from such modification.

### BACKGROUND OF THE INVENTION

Alkyd based single component air drying coatings are known for bottom of the pyramid economical paints and provide limited corrosion resistance and weathering performance. Present invention aims to overcome these limitations through uniquely designed silicone functionalized urethane alkyd resin providing superior performance characteristics in respect of corrosion resistance, weathering, and mechanical properties when incorporated in a suitably designed pigmented coating composition.

Amongst various performance expectations from a coating, protection against corrosion of mild steel is of major commercial significance considering huge losses of steel being incurred due to corrosion resulting in the weakening of the structures requiring replacement and repair. Thus, efforts to develop more efficient and environmentally compliant methods to prevent corrosion have been going on across the globe.

There are anti-corrosive paints available in the market based on epoxy, polyurethane, organic or inorganic zinc-rich coatings etc. largely for industrial use. These coating compositions are mostly 2K systems requiring measured quantities of the components to be mixed prior to use and employ hazardous aggressive solvents. Limited pot life and difficult to clean the coating equipment after the job is another hassle in two component coating systems. Such coating systems generally require multiple coating layers to be deposited to achieve desired overall high dry film thickness necessary for barrier protection. It is practically not feasible for a wider cross-section of domestic users to apply such kind of a coating system.

Considering single component oxidative crosslinking, high renewable content and possibility to employ environmentally safer Mineral Turpentine Oil as solvent, it was decided to build desired aesthetics and high weathering and corrosion resistance performance in an alkyd coating by suitably reinforcing alkyd resin backbone.

In the light of the present invention, some of the prior arts dealing with silicone and urethane modifications of alkyd resins as well as their use in coatings including in self priming coating compositions are being described herein:

PCT application No. WO/2008/148716 titled as “Polysiloxane and urethane modified water-reducible alkyd resins” discloses Urethane and siloxane modified water-reducible alkyd resins, which form the two most essential embodiments of the invention. Further, claim 1 of the aforesaid invention claims polyhydric alcohols, modified fatty acids made by grafting olefinically unsaturated carboxylic acids onto fatty acids, ungrafted fatty acids, silanol or alkoxysilyl functional siloxane oligomers or polymers, and polyfunctional isocyanates.

European Application No. EP2155801 titled as “Polysiloxane and urethane modified water-reducible alkyd resins” also discloses process for the synthesis of siloxane and urethane-modified water-reducible alkyd resins.

US application No. 20160244615 titled as “Metal effect pigments modified with a silane layer containing at least two different bifunctional silanes” discloses about use of certain metals along with silanes.

U.S. Pat. No. 3,627,722 titled as “Polyurethane sealant containing trialkyloxysilane end groups” discloses about presence of silane groups present at the ends of the polyurethane polymer chains

US application No. U.S. Ser. No. 05/637,813 titled as “Silanol-containing urethane dispersions” discloses poly (urethane-urea) terminated by hydrolyzable or hydrolyzed silyl groups.

European application No. EP0967235 titled as “Silicon-modified resins based on recurring units derived from allyl alcohol and their use in weather-resistant coatings” discloses about silicon-modified alkyd resins. The process discloses herein comprises reacting: A) at least one organosilicon compound B) at least one resin obtainable by reacting at least one fatty acid agent with at least one polyhydric polymer having an average OH functionality of about 2 to 25.

Chinese patent CN 102134441 Titled ‘Organic silicon Polyurethane composite modified alkyd resin coating composition and preparation method thereof’ by Chen Yun et al discloses about a silicone-modified alkyd resin composite polyurethane coating compositions and methods of preparation. The two-component coating compositions comprising of modified active polysiloxane in component A and alkyd resin, solvent, pigment, filler and additives in component B. The two are mixed together when in use. The coating composition of the invention provides good adhesion, resistance to salt spray, salt water, anti-aging and excellent overall performance for the heavy steel anti-corrosion coating protection.

U.S. Pat. No. 5,539,032 Titled ‘Corrosion Resistant Self-Priming alkyd top coats’ by Charles R Hegedus et al. discloses about coatings comprising of high dosages of anticorrosive pigments like aluminium triphosphate, zinc benzoate and an alkaline earth metal phosphate using Silicone Alkyd co-polymer. The coating is recommended for pretreated and unprimed metal to be cured at ambient or elevated temperature. The preferred embodiment of invention mentions corrosion resistance for periods ranging upto 500 hrs in SO2-Salt Fog test and upto 1000 hrs in the salt Fog test for coatings applied up to about 10 mils thickness and preferably upto 1-3 mils.

U.S. Pat. No. 5,089,551 Titled ‘Corrosion Resistant Alkyd Coatings’ by Charles R Hegedus et al describes about corrosion-resistant coating suitable for metal/plastic substrates as a single coat providing high-gloss and good adhesion/flexibility. The coating comprises of a Silicone alkyd resin and corrosion inhibiting pigments consisting of zinc-barium phosphate, zinc molybdate and at least one zinc salt of a benzoic acid and an organic solvent.

EP1499690A1 and U.S. Pat. No. 7,208,537 B2 Titled ‘Self Priming chromate free Corrosion Resistant Coating composition and method’ by Dhrubo Bhattacharya discloses about self-priming rapid curing chromate free corrosion resistant coating composition based on a polyvinyl terpolymer and an alkyd resin with hydroxyl number of 80-200 along with mineral acid catalyst and one or more organic solvents and a drying agent. The composition can be applied as a clear coat or as a pigmented composition with addition of pigments on ferrous and non-ferrous metallic substrate and is particularly suitable for continuous coil coating lines for curing at high temp of 180-280° C. Being heat curing, this invention is not within the scope of present invention.

U.S. Pat. No. 5,021,489 Titled ‘Corrosion inhibiting coating Composition by Walter E. Knight et al discloses about Corrosion inhibiting film forming compositions which displace moisture from the metal substrate. Such coating compositions comprise of an acrylic resin, a silicone resin and a copolymer derived from silicone and alkyd resin. The oil soluble petroleum sulfonates along with alkyl ammonium phosphate has been used to inhibit corrosion of the metal substrate. The organic solvent used comprises of aromatic hydrocarbon, glycol ether and cellosolve acetate.

None of the available prior arts make an explicit disclosure with respect to preparation of silicone functionalized urethane alkyd resin and its subsequent use in solvent borne single component air drying coating compositions providing excellent corrosion resistance, weathering and mechanical properties.

Apart from the above there are references on two component epoxy and polyurethane systems to provide corrosion resistance performance but such multi component and multi product systems are not part of the scope of the present invention.

### OBJECTS OF THE INVENTION

An object of the present invention is to design functionalized alkyd suitable for glossy weatherable top coat/self-priming anti corrosive coatings to combine aesthetics and corrosion protection in a single component ready to use paint without the need of a primer for new and old mild steel structures.

Another object of the present invention is to propose functionalized urethane alkyd or more particularly siliconized urethane alkyd resin for single pack ready to use corrosion and weather resistant top coats/self-priming enamel/under coat/primer for maintenance of old mild steel structures which presently require extensive surface preparation and employ multi product and multi coat systems such as 2K epoxy and polyurethanes. Use of such systems is quite cumbersome and not feasible for domestic users.

Further object of the present invention is to propose that the entire reaction of grafting epoxy alkyl alkoxy silane or silanol functional silicone resin is followed by urethanization and is carried out in-situ.

Yet another object of the present invention is to propose epoxy alkyl alkoxy silane which is conventionally used as a coupling agent and as an adhesion promoter in the paint composition has been pre-reacted in to the alkyd backbone enabling better utilization of functionalities and enhanced corrosion resistance performance. This eliminated the use of epoxy alkyl alkoxy silane in the coating composition.

Still further object of the present invention, is to propose grafting of epoxy alkyl alkoxy silane into alkyd backbone followed by urethane resulted into significantly high weathering and corrosion resistant performance which is not obtained/reported from conventional alkyd or urethane alkyds free from such modification.

Still another object of the present invention, is to propose that the functionalized urethane alkyd has been designed to ensure excellent solubility in commonly used mineral turpentine oil which is a mix of aliphatic/aromatic hydrocarbons and safer for domestic painting purposes.

Yet another object of present invention, is to propose that superior drying and hardness was facilitated using a unique combination of metallic driers providing faster recoat ability leading to significant reduction in recoat time of 4-8 hours in comparison to >8 hours of conventional alkyds. This significantly reduced the time for completing painting activity.

Further object of the present invention is to propose that vegetable oil fatty acids being major ingredient have been selected in a manner providing high unsaturation for excellent drying performance while keeping linolenic acid content responsible for yellowing in a coating to preferably <10% but not limiting to if non-yellowing performance is not of a prime concern.

Still further object of the present invention is to provide a process for the synthesis of base alkyd resin followed by grafting of organosilanes into alkyd backbone which is further reacted with polyisocyanate to partially convert free hydroxyls into urethane linkages resulting into silicone functional urethane alkyds.

Yet another object of the present invention, apart from gloss and color retention, the said functionalized urethane alkyd based Top coat/self-priming enamel provides excellent corrosion protection to mild steel in different geographical and climatic conditions including highly aggressive coastal environments. The coatings designed thereof would also provide protection to old corroded mild steel substrates after proper cleaning through hand tools like wire brush and sand paper etc.

Another object of the present invention, is to propose that such functionalized urethane alkyd resin when employed in paint recipe incorporating corrosion inhibiting pigment and additives known in the art provided superior gloss, corrosion resistance, mechanical properties and weathering performance especially in respect of gloss/non-yellowing.

### BRIEF DESCRIPTION OF THE INVENTION

This invention relates to a siliconized urethane alkyd resin composition comprising:

a base alkyd resin component having hydroxyl number in the range of 50-150 mg KOH/gm, and acid number of 10 mg KOH/gm or less; a reaction product of reactive sub-components selected from the groups consisting of polyhydric alcohols, polybasic carboxylic acids and anhydrides thereof, hydroxycarboxylic acids, monofunctional carboxylic acids and vegetable oils or their fatty acids;

an organosilane component comprising one or more organosilanes having functional groups selected from one or more from the groups consisting of epoxide, alkoxy silane and silanol; and an isocyanate component comprising one or more aliphatic, cycloaliphatic and aromatic isocyanate compounds having isocyanate functionality of 1 or more, wherein the isocyanate component consumes 40 to 70% of the initial OH number of above component.

The present invention relates to functionalized urethane alkyd or more particularly siliconized urethane alkyd resin for single pack ready to use corrosion and weather resistant coatings/self-priming enamel for maintenance of new and old mild steel structures/objects which presently require extensive surface preparation and employ multi product and multi coat systems such as 2K epoxy and polyurethanes. Use of such systems is quite cumbersome and not feasible for domestic users.

Presently there is no paint reported based on single component air drying siliconized urethane alkyd chemistry which provides the attributes of self-priming, high gloss, fast drying, non-yellowing and excellent weathering resistance and corrosion resistance as per Salt Fog resistance of 1000 hours or more when applied in 3 or more coats at an interval of minimum 4-8 hours at a total dry film thickness (DFT) of 75 -90 microns.

Present invention also relates to the synthesis of functionalized alkyd obtained from an alkyd based on drying and semi drying oils or their fatty acids having high iodine number of 120-170 (gm I₂/100 gm) with linolenic acid content preferably <10% but not limited to for achieving outstanding corrosion resistance and weathering performance in respect of gloss retention and non-yellowing. At the end of alkyd preparation, residual carboxylic acid and hydroxyl groups present in such alkyd are reacted with epoxy alkyl alkoxy silane and/or silanol functional silicone resin and siliconized alkyd thus obtained is further reacted with aliphatic/cycloaliphatic/aromatic polyisocyanates or their derivates to create urethane linkages.

Advantageously the entire process of said silicone functionalized urethane alkyd involves following in-situ steps:

Base Alkyd having molecular weight of 3000-12000 was obtained from the reaction of Polyhydric alcohols, Poly functional carboxylic acids/anhydrides and monofunctional carboxylic acids in combination with drying and semi drying oils/fatty acids such as Dehydrated Castor Oil fatty acid, Sunflower fatty acid, soya bean oil fatty acid, Safflower fatty acid and linseed oil fatty acids or similar having iodine number of 120-170 (gm I₂/100 gm). The alkyd was processed at 170-250° C. till an acid number of <10 mg KOH/gm is achieved. The resultant alkyd has hydroxyl number of 50-150 mg KOH/gm and preferably 75-125 mg KOH/gm.

Alkyd resin thus obtained was further grafted with epoxide functional silicone i.e. [3-(2,3-Epoxypropoxy)propyl]trimethoxysilane], [3,4-epoxycyclohexyl trimethoxy silane] or similar functional organosilanes or silanol functional resin intermediates suitable to react with free carboxylic and hydroxyl functionality of alkyds at dosage of 0.5-5% of base alkyd resin at 130-220° C. till an acid number of <5 is achieved. Here free carboxylic group of alkyd resin reacts with oxirane ring of said epoxy alkyl alkoxy silane while alkoxy silane hydrolyzes forming silanol which undergoes condensation providing siloxane bond. Silanol reacts with hydroxyl functionality of alkyd resulting in silicone organic copolymer. Molecular weight of such functionalized alkyd ranges from 4000-15000 and more preferably 5000-12000.

Siliconized alkyd resin as obtained above is further reacted with optimized dosages of Aliphatic/Cycloaliphatic/Aromatic Polyisocyanates or their derivatives to introduce urethane linkages to get siliconized urethane alkyd having Molecular weight of 15000-50000 and more preferably 20000-35000.

Importantly, in another aspect of the present invention, incorporation of organosilane into the alkyd backbone could be achieved due to the termination of alkyd synthesis at an acid number of <10 (mg KOH/gm) as well as conducting reaction at optimized temperature/Time necessary to obtain the silicone grafted alkyd suitable for further reaction with polyisocyanate avoiding premature gelation.

According to another aspect of the present invention, the said silicone functionalized urethane alkyd has been designed to ensure excellent solubility in commonly used mineral turpentine oil (MTO) which is a mix of aliphatic/aromatic hydrocarbons and preferred choice for domestic painting applications owing to various advantages offered by such solvent including excellent recoat ability, low odor, higher flash point and low cost.

In one of the embodiment of present invention, superior drying and hardness was also facilitated using an unconventional combination of metallic driers i.e. octoates/naphthenates of cobalt, zirconium, calcium and iron complex enabling recoat time of 4-8 hours in comparison to >8 hours of conventional urethane alkyds. This significantly reduces the cycle time for completing the painting activity.

It is a finding of the present invention that such silicone functionalized urethane alkyd resin when used in paint recipe incorporating organic pigment, inorganic pigment, corrosion inhibiting pigment and additives known in the art provide good gloss, corrosion resistance, mechanical properties and weathering performance especially in respect of gloss retention/non-yellowing.

Surprisingly the siliconized urethane alkyd as stated above provided outstanding corrosion resistance on new as well as corroded mild steel and other metallic substrates when suitably formulated in pigmented coating compositions comprising of Inorganic/organic pigments, anticorrosive pigments, dispersing agents, metallic driers, UV light absorbers, hindered amine light stabilizers, anti-skin agent, flow and levelling additives and solvents. Preferred dry film thickness of the coating for achieving optimum performance properties is 75-90 microns in 3 coats while ensuring a time interval of 4-8 hours between the coats.

### DETAILED DESCRIPTION OF THE INVENTION

The present invention resides essentially in the formulation and process of silicone functionalized urethane alkyd and its use in air drying Top coat/self-priming enamel/under coat/primer providing outstanding corrosion and weathering performance when incorporated in suitably designed pigmented coating compositions.

The present invention is primarily directed to metal as a Top coat/self-Priming glossy coating composition comprising of said siliconized urethane alkyd, organic/inorganics pigments including anti-corrosive pigments, metallic driers, UV light absorbers, hindered amine light stabilizers, Anti-skin agent, solvent and additives for decorative, general industrial and auto refinish application. However, the coating designed thereof would also find suitability to decorate and protect other substrates as well like wood, glass and masonry etc.

One of the principle aspects of the present invention relates to the development of a polymeric binder for corrosion resistant and weatherable coatings and composition of the same according to the invention is being described here in detail.

The present invention deals with a silicone functionalized urethane alkyd obtained from alkyd based on drying/semidrying Oils or their fatty acid having Iodine Number of 120-170 (gm I₂/100 gm) with linolenic acid content preferably <10% but not limited to and subsequent reaction of residual carboxylic and hydroxyl groups present in such alkyd with epoxy functional alkoxy silane and/or with silanol functional silicone resins which are further reacted with aliphatic, cycloaliphatic and aromatic polyisocyanates or their derivatives to impart urethane linkages.

Reaction of epoxy alkyl alkoxy silane and/or silanol functional silicone resins into the alkyd backbone facilitates improved adhesion, heat and UV resistance due to the formation of stable covalent bonds of M—O—SI (M=Fe, Al, Si) and an interpenetrating polymer network. Grafting with epoxy alkyl alkoxy silane facilitated reaction of oxirane group with the residual carboxylic functionality available in the alkyd which otherwise remains unutilized when epoxy alkyl alkoxy silane is used as an additive coupling agent in the coating composition. Even hydrolysis of epoxy alkyl alkoxy silane necessary to impart desired effect in a crosslinked pigmented coating matrix would be gradual at ambient temperature.

Through their dual reactivity, organosilanes act as bridge between inorganic substrates and polymer matrices. In view of this chemically grafting epoxy alkyl alkoxy silane at elevated temperature into the alkyd backbone followed by urethanization provides paints with superior adhesion, corrosion resistance and weathering performance over paint based on urethane alkyd of similar construction minus such modification.

Advantageously, in another aspect of the present invention this entire reaction of preparing base alkyd followed by grafting epoxy alkyl alkoxy silane and/or silanol functional silicone resin and subsequent urethanization has been carried out in-situ.

In one aspect of the present invention, the silicone functionalized urethane alkyd has been designed to get excellent solubility in commonly used mineral turpentine oil which is a mix of aliphatic/aromatic hydrocarbons and preferred choice for domestic painting use over other organic solvents considering strong smell, low flash points and hazards associated with them in addition to the high costs. Use of mineral turpentine oil also offers improved recoat ability and overall economy to the coating recipe.

The Alkyd resin used in the present invention was obtained from semi drying/drying oils or their fatty acids, polyhydric alcohols, polybasic carboxylic acid or their anhydrides and monocarboxylic acids. The base alkyd was designed to have free OH functionality with hydroxyl number of 50-150 mg KOH/gm and processed to an acid number of <10 mg KOH/gm required for further reaction with organosilanes and polyisocyanates.

The vegetable Oils and their fatty acids used for base alkyd of the present invention include Soya bean Oil, Sunflower Oil, dehydrated castor Oil, Safflower Oil, Tobacco seed Oil, Tung oil etc or a mixture thereof preferably having Linolenic acid content of <10%. However, the invention includes other Oil/fatty acids having higher linolenic acid content such as Linseed Oil, Rubber seed Oil, Niger Seed Oil, Perilla oil, Hemp seed Oil, Tall Oil etc or a customized mixture thereof available under different brands from various suppliers if non yellowing performance of the final alkyd is not of prime concern. Vegetable oil fatty acids have been preferred in the present invention to achieve superior color and drying of the siliconized urethane alkyds. The amount of such oils or fatty acids may vary from 25-80% of resin solids and more preferably 40-70%.

The polyols/polyhydric alcohols suitable for the practice of the present invention having two or more hydroxyl groups per molecule. There are many polyols known in the art, or mixtures thereof, such as trimethyl pentanediol, diethylene glycol, neopentyl glycol, glycerol, pentaerythritol, trimethylolethane, trimethylol propane, methane propane diol, butyl ethyl propane diol, cyclohexane dimethylol; 1,6 hexane diol; 1,4 butane diol, sorbitol, _immer_1 pivalic acid neopentyl glycol ester and similar polyols or a mixture thereof. This also includes use of dual functional monomers in the alkyd backbone having carboxylic and hydroxyl functionality like dimethylol propionic acid or epoxy functional monomer and polymers which may create OH functionality during reaction. The amount of such polyols or dual functional monomers would vary from 8-35% and more preferably 12-30% based on alkyd resin solids.

The polybasic acids or acid anhydrides suitable towards the synthesis of base alkyd of the present invention include isophthalic acid, terephthalic acid, phthalic anhydride, trimellitic anhydride; 1,4 cyclohexane dicarboxylic acid; 1,2 cyclohexane dicarboxylic acid anhydride, maleopimaric acid, _immer fatty acid as well as other aromatic or cycloaliphatic acid anhydride as such or in combination thereof.

However, the preferred ones are phthalic anhydride and isophthalic acid. The amount of aromatic dicarboxylic acid would vary depending on the oil length of base alkyd and extent of intended grafting of organosilanes and subsequent reaction with polyisocyanates. The amount of polybasic acids or their anhydride may vary form 8-35% and more preferably 12-30% based on alkyd resin solids. In the present invention Phthalic anhydride has been preferred over other carboxylic acids/anhydrides to make the resin commercially viable.

Suitable mono functional carboxylic acids for the present invention include benzoic acid, tertiary butyl benzoic acid, abietic acid (Rosin) and cyclohexane carboxylic acid as chain terminator, but preferred one is benzoic acid. The amount of aromatic carboxylic acid can vary from 0-15% and preferably 0-8% based on total ingredients of base alkyd.

The esterification catalyst suitable for the synthesis of base alkyd of the present invention include dibutyl tin oxide, Lithium hydroxide, Lithium salts of fatty acids/carboxylic acids and metal salts or their oxides known for esterification and transesterification. However, such catalyst would necessarily be required for Oil based alkyd synthesis requiring monoglyceride formation but alkyd synthesis starting from Oil fatty acid may also be carried out in the absence of such catalysts with a little longer esterification/polymerization time.

Preferred Reflux solvent employed for the base alkyd preparation was O-xylene or its isomers to the extent of 1-7% and more preferably 3-5%. However other solvent like methyl n-amyl ketone or similar may be used wherever nonaromatic solvent is the preferred choice.

In the second step of the reaction, organosilanes suitable for incorporation into the alkyd backbone include [3-(2,3-Epoxypropoxy)propyl]trimethoxysilane], [3,4 epoxycyclohexyl trimethoxy silane] or similar functional silane or silanol functional resin intermediates suitable to react with carboxylic and hydroxyl functional base alkyd resin at 130-220° C. till an acid number of <5 is achieved. Here preferred dosage of such organosilane incorporation in respect of epoxy alkyl alkoxy silane is 0.5-5% and more preferably 0.5 -3% based on alkyd resin solids whereas preferred organosilane incorporation in respect of silanol functional silicone resin intermediates varies from 2.0-20% and more preferably 2-10%.

In the third and final step of forming siliconized urethane alkyd, silicone grafted alkyd prepared in second stage is reacted with an aliphatic, cycloaliphatic or aromatic polyisocyanate or their derivatives. In the present invention cycloaliphatic polyisocyanate i.e Isophorone diisocyanate (IPDI) has been preferred over aromatic diisocyanate like toluene diisocyanate for superior weathering performance especially in respect of gloss and non-yellowing. For the purpose of present invention, amount of IPDI may vary from 1-10% on siliconized alkyd solids and more preferably 2-5%.

The catalyst used for the reaction of free hydroxyls with polyisocyanate include compounds of metal salts or esters of tin, Zinc, Zirconium etc. such as dibutyl tin dilaurate, zinc octoate, zirconium octoate etc. at effectively low metal contents to facilitate faster reaction especially with less reactive aliphatic or cycloaliphatic polyisocyanates.

The siliconized urethane alkyd involving aforesaid formulation and process steps may be produced at up to 90% nonvolatile content and more preferably up to a nonvolatile content of 75%. The viscosity of such siliconized urethane would entirely depend on various factors such as composition of base alkyd, extent of organosilanes grafting, extent of polyisocyanate modification including process control at various stages of preparation.

The following examples illustrate certain embodiment and aspects of the present invention and not to be construed as limiting the scope thereof. All parts and percentages are by weight basis unless otherwise stated.

### EXAMPLE 1

An urethane alkyd resin was prepared by charging the following constituents into a four-necked reactor flask equipped with a temperature controller, heating mantle, nitrogen purger, overhead stirrer and Dean Stark assembly.

| Ingredients | Parts by Weight |
|---|---|
| Soya bean oil Fatty acid | 25.74 |
| Phthalic anhydride | 11.00 |
| Pentaerythritol (Nitration grade) | 11.90 |
| Benzoic acid | 4.97 |
| Dibutyl Tin Oxide | 0.10 |
| O-Xylene | 4.15 |
| Toluene Diisocyanate | 2.47 |
| Mineral Turpentine Oil | 39.67 |
| Total | 100.00 |

Soya bean oil Fatty acid, phthalic anhydride Pentaerythritol, benzoic acid, Dibutyl Tin Oxide and O-xylene as reflux solvent were charged into the aforesaid reaction assembly and reaction mass was slowly heated to a temperature up to 230° C. under azeotropic distillation with removal of water of reaction periodically till an acid number of <10 mg KOH/g and dilution viscosity (25° C. on Gardner scale) at 55% NVM in mineral turpentine oil of U-V is achieved. Once the desired constants are achieved, reaction mixture is cooled to 80-90° C. and further reacted with Toluene diisocyanate at 80-90° C. and maintained for 4-6 hours till constant viscosity is achieved. A clear Urethane alkyd solution is obtained with approx. 55% nonvolatile content, hydroxyl number (mg KOH/gm) 81.50 and viscosity of Y-Z at 25° C. on Gardner scale. The resin was tested for accelerated stability at 55° C. for 15 days and no appreciable change in viscosity was observed.

The urethane alkyd resin thus obtained was used to prepare white Paint at a PVC of 14-20% using Titanium dioxide, Zinc phosphate, dispersing agent, metallic driers, UV light absorbers, hindered amine light stabilizers and flow-levelling additives. The resulting paint was tested for drying, physical, mechanical, weathering and corrosion resistance performance and test results are summarized in the table.

### EXAMPLE 2

An urethane alkyd resin was prepared by charging the following constituents into a four-necked reactor flask equipped with a temperature controller, heating mantle, nitrogen purger, overhead stirrer and Dean Stark assembly.

| Ingredients | Parts by Weight |
|---|---|
| Soya bean oil Fatty acid | 25.87 |
| Phthalic anhydride | 10.79 |
| Pentaerythritol Nitration Grade | 11.69 |
| Benzoic acid | 4.88 |
| Dibutyl Tin Oxide | 0.10 |
| O-Xylene | 4.11 |
| Dibutyl Tin dilaurate | 0.05 |
| Isophorone Diisocyanate | 2.70 |
| Mineral Turpentine Oil | 39.81 |
| Total | 100.00 |

Soya bean oil Fatty acid, phthalic anhydride Pentaerythritol, benzoic acid, Dibutyl Tin Oxide and O-xylene as reflux solvent were charged into the aforesaid reaction assembly and reaction mass was slowly heated to a temperature up to 230° C. under azeotropic distillation with removal of water of reaction periodically till an acid number of <10 mg KOH/g and viscosity (25° C. on Gardner scale) at 55% NVM in mineral turpentine oil of U-V is achieved. Once the desired constants are achieved, reaction mixture is cooled to 80-90° C., added Dibutyl Tin dilaurate and further reacted with Isophorone Diisocyanate at 80-90 ° C. and maintained for 4-6 hours till constant viscosity is achieved. A clear Urethane alkyd solution is obtained with approx. 55% nonvolatile content, hydroxyl number (mg KOH/gm) 78.10 and dilution viscosity of X-Y at 25° C. on Gardner scale. The resin was tested for accelerated stability at 55° C. for 15 days and no appreciable change in viscosity was observed.

The urethane alkyd resin thus obtained was used to prepare white Paint at a PVC of 14-20% using Titanium dioxide, Zinc phosphate, dispersing agent, metallic driers, UV light absorbers, hindered amine light stabilizers and flow-levelling additives. The resulting paint was tested for drying, physical, mechanical, weathering and corrosion resistance performance and test results are summarized in the table.

### EXAMPLE 3

An urethane alkyd resin was prepared by charging the following constituents into a four-necked reactor flask equipped with a temperature controller, heating mantle, nitrogen purger, overhead stirrer and Dean Stark assembly.

| Ingredients | Parts by Weight |
|---|---|
| Soya bean oil Fatty acid | 31.75 |
| Phthalic anhydride | 13.56 |
| Pentaerythritol Nitration Grade | 11.34 |
| Trimethylol Propane | 1.89 |
| Benzoic acid | 1.66 |
| Dibutyl Tin Oxide | 0.10 |
| O-Xylene | 2.50 |
| Isophorone Diisocyanate | 1.47 |
| Mineral Turpentine Oil | 35.83 |
| Total | 100.00 |

Soya bean oil Fatty acid, phthalic anhydride Pentaerythritol, Trimethylol propane, benzoic acid, Dibutyl Tin Oxide and O-xylene as reflux solvent were charged into the aforesaid reaction assembly and reaction mass was slowly heated to a temperature upto 230° C. under azeotropic distillation with removal of water of reaction periodically till an acid number of <10 mg KOH/g and dilution viscosity (25° C. on Gardner scale) at 60% NVM in mineral turpentine oil of V-W is achieved. Once the desired constants are achieved, reaction mixture is cooled to 80-90° C. and further reacted with Isophorone Diisocyanate at 80-90 ° C. and maintained for 4-6 hours till constant viscosity is achieved. A clear Urethane alkyd solution is obtained with approx. 60% nonvolatile content, hydroxyl number (mg KOH/gm) 68.54 and viscosity of Y-Z at 25° C. on Gardner scale. The resin was tested for accelerated stability at 55° C. for 15 days and no appreciable change in viscosity was observed.

The urethane alkyd resin thus obtained was used to prepare white Paint at a PVC of 14-20% using Titanium dioxide, Zinc phosphate, dispersing agent, metallic driers, UV light absorbers, hindered amine light stabilizers and flow-levelling additives. The resulting paint was tested for drying, physical, mechanical, weathering and corrosion resistance performance and test results are summarized in the table.

### EXAMPLE 4

An urethane alkyd resin is prepared by charging the following constituents into a four-necked reactor flask equipped with a temperature controller, heating mantle, nitrogen purger, overhead stirrer and Dean Stark assembly.

| Ingredients | Parts by Weight |
|---|---|
| Mixed Fatty acid (Iodine number 155 gm | 25.38 |
| I₂/100 gm & Linolenic acid content 22%) | |
| Phthalic anhydride | 10.86 |
| Pentaerythritol Nitration Grade | 11.77 |
| Trimethylol Propane | 1.89 |
| Benzoic acid | 4.92 |
| Dibutyl Tin Oxide | 0.10 |
| O-Xylene | 3.08 |
| Isophorone Diisocyanate | 3.00 |
| Mineral Turpentine Oil | 39.00 |
| Total | 100.00 |

Mixed Fatty acid (Iodine number 155 gm I₂ /100 gm & Linolenic acid content 22%) , phthalic anhydride, Pentaerythritol, Trimethylol propane, benzoic acid and O-xylene as reflux solvent were charged into the aforesaid reaction assembly and reaction mass was slowly heated to a temperature upto 230° C. under azeotropic distillation with removal of water of reaction periodically till an acid number of <10 mg KOH/g and dilution viscosity (25° C. on Gardner scale) at 55% NVM in mineral turpentine oil of T-U is achieved. Once the desired constants are achieved, reaction mixture is cooled to 80-90° C. and further reacted with Isophorone Diisocyanate at 80-90 ° C. and maintained for 4-6 hours till constant viscosity is achieved. A clear Urethane alkyd solution is obtained with approx. 55% non volatile content, hydroxyl number (mg KOH/gm) 125.30 and viscosity of Z-Z1 at 25° C. on Gardner scale. The resin was tested for accelerated stability at 55° C. for 15 days and no appreciable change in viscosity was observed.

The urethane alkyd resin thus obtained was used to prepare white Paint at a PVC of 14-20% using Titanium dioxide, Zinc phosphate, dispersing agent, metallic driers, UV light absorbers, hindered amine light stabilizers and flow-levelling additives. The resulting paint was tested for drying, physical, mechanical, weathering and corrosion resistance performance and test results are summarized in the table.

### EXAMPLE 5

A silicone resin grafted urethane alkyd resin was prepared by charging the following constituents into a four-necked reactor flask equipped with a temperature controller, heating mantle, nitrogen purger, overhead stirrer and Dean Stark assembly.

| Ingredients | Parts by Weight |
|---|---|
| Soya bean oil Fatty acid | 25.00 |
| Phthalic anhydride | 11.00 |
| Pentaerythritol nitration grade | 11.64 |
| Benzoic acid | 5.00 |
| Dibutyl Tin Oxide | 0.10 |
| O-Xylene | 3.92 |
| Xiameter RSN Z 6018 | 2.08 |
| Dibutyl Tin dilaurate | 0.05 |
| Isophorone Diisocyanate | 3.21 |
| Mineral Turpentine Oil | 38.0 |
| Total | 100.00 |

Soya bean oil Fatty acid, phthalic anhydride Pentaerythritol, benzoic acid and O-xylene as reflux solvent were charged into the aforesaid reaction assembly and reaction mass was slowly heated to a temperature upto 230° C. under azeotropic distillation with removal of water of reaction periodically till an acid number of <10 mg KOH/g and dilution viscosity (25° C. on Gardner scale) at 55% NVM in mineral turpentine oil of U-V is achieved. Once the desired constants are achieved, reaction mixture is cooled to 180-190° C. and reacted with Xiameter RSN Z 6018 at batch temperature 180-210° C. for 2-3 hours till an acid number of <5 mg KOH/gm is achieved. The reaction mass was further reacted with Isophorone Diisocyanate at 80-90° C. in presence of Dibutyl Tin dilaurate and maintained for 4-6 hours till constant viscosity is achieved. A clear siliconized urethane alkyd solution is obtained with approx. 55% nonvolatile content, hydroxyl number (mg KOH/gm) 80.45 and viscosity of Z2-Z3 at 25° C. on Gardner scale. The resin was tested for accelerated stability at 55° C. for 15 days and no appreciable change in viscosity was observed.

The siliconized urethane alkyd resin thus obtained was used to prepare white Paint at a PVC of 14-20% using Titanium dioxide, Zinc phosphate, dispersing agent, metallic driers, UV light absorbers, hindered amine light stabilizers and flow-levelling additives. The resulting paint was tested for drying, physical, mechanical, weathering and corrosion resistance performance and test results are summarized in the table.

### EXAMPLE 6

A silicone resin grafted urethane alkyd was prepared by charging the following constituents into a four-necked reactor flask equipped with a temperature controller, heating mantle, nitrogen purger, overhead stirrer and Dean Stark assembly.

| Ingredients | Parts by Weight |
|---|---|
| Soya bean oil Fatty acid | 25.00 |
| Phthalic anhydride | 11.00 |
| Pentaerythritol nitration grade | 11.64 |
| Benzoic acid | 5.00 |
| Dibutyl Tin Oxide | 0.10 |
| O-Xylene | 7.02 |
| Xiameter RSN Z 6018 | 2.08 |
| Dibutyl Tin dilaurate | 0.05 |
| Toluene Diisocyanate | 2.47 |
| Mineral Turpentine Oil | 35.64 |
| Total | 100.00 |

Soya bean oil Fatty acid, phthalic anhydride Pentaerythritol, benzoic acid, Dibutyl Tin Oxide and O-xylene as reflux solvent were charged into the aforesaid reaction assembly and reaction mass was slowly heated to a temperature upto 230° C. under azeotropic distillation with removal of water of reaction periodically till an acid number of <10 mg KOH/g and dilution viscosity (25° C. on Gardner scale) at 55% NVM in mineral turpentine oil of V-W is achieved. Once the desired constants are achieved, reaction mixture is cooled to 180-190° C. and reacted with Xiameter RSN Z 6018 at batch temperature 180-210° C. for 2-3 hours till an acid number of <5 mg KOH/gm is achieved. The reaction mass was further reacted with Toluene Diisocyanate at 80-90 ° C. in presence of Dibutyl Tin dilaurate and maintained for 4-6 hours till constant viscosity is achieved.

A clear siliconized urethane alkyd solution is obtained with approx. 55% nonvolatile content, hydroxyl number (mg KOH/gm) 79. 65 and viscosity of Z1-Z2 at 25° C. on Gardner scale. The resin was tested for accelerated stability at 55° C. for 15 days and no appreciable change in viscosity was observed.

The siliconized urethane alkyd resin thus obtained was used to prepare white Paint at a PVC of 14-20% using Titanium dioxide, Zinc phosphate, dispersing agent, metallic driers, UV light absorbers, hindered amine light stabilizers and flow-levelling additives. The resulting paint was tested for drying, physical, mechanical, weathering and corrosion resistance performance and test results are summarized in the table.

### EXAMPLE 7

A silicone functional urethane alkyd resin was prepared by charging the following constituents into a four-necked reactor flask equipped with a temperature controller, heating mantle, nitrogen purger, overhead stirrer and Dean Stark assembly.

| Ingredients | Parts by Weight |
|---|---|
| Soya bean Oil Fatty acid | 25.27 |
| Phthalic anhydride | 10.79 |
| Pentaerythritol Nitration Grade | 11.69 |
| Benzoic Acid | 4.88 |
| Dibutyl tin Oxide | 0.10 |
| O-Xylene | 4.11 |
| 3-(2,3-Epoxypropoxy)propyl] trimethoxysilane | 0.7 |
| Dibutyl Tin dilaurate | 0.05 |
| Isophorone Diisocyanate | 3.10 |
| Mineral Turpentine Oil | 39.31 |
| Total | 100.00 |

Soya bean Oil Fatty acid, phthalic anhydride, Pentaerythritol, benzoic acid, Dibutyl tin Oxide and O-xylene as reflux solvent were charged into the aforesaid reaction assembly and reaction mass was slowly heated to a temperature of up to 230° C. under azeotropic distillation with removal of water of reaction periodically till an acid number of <10 mg KOH/g and dilution viscosity (25° C. on Gardner scale) at 55% NVM in mineral turpentine oil of T-U is achieved. Once the desired constants are achieved, reaction mixture is cooled to 160-180° C. and reacted with 3-(2,3-Epoxypropoxy) propyl trimethoxysilane. Methanol and water produced during the reaction along with O-xylene were distilled off and reaction temperature was slowly raised to 200-220° C. and maintained for 2-3 hours till an acid number of <5 mg KOH/gm is achieved. The reaction mass was added with dibutyl tin dilaurate and further reacted with Isophorone Diisocyanate at 80-90° C. and maintained for 4-6 hours till constant viscosity is achieved. A clear silicone functional urethane alkyd solution is obtained with approx. 55% nonvolatile content, hydroxyl number (mg KOH/gm) 82.65 and viscosity of Z3-Z4 at 25° C. on Gardner scale. The resin was tested for accelerated stability at 55° C. for 15 days and no appreciable change in viscosity was observed.

The silicone functional urethane alkyd resin thus obtained was used to prepare white Paint at a PVC of 14-20% using Titanium dioxide, Zinc phosphate, dispersing agent, metallic driers, UV light absorbers, hindered amine light stabilizers and flow-levelling additives. The resulting paint was tested for drying, physical, mechanical, weathering and corrosion resistance performance and test results are summarized in the table.

### EXAMPLE 8

A silicone functional urethane alkyd resin was prepared by charging the following constituents into a four-necked reactor flask equipped with a temperature controller, heating mantle, nitrogen purger, overhead stirrer and Dean Stark assembly.

| Ingredients | Parts by Weight |
|---|---|
| Dehydrated Castor Oil Fatty acid | 27.19 |
| Phthalic anhydride | 9.74 |
| Pentaerythritol Nitration Grade | 12.36 |
| Benzoic acid | 4.41 |
| Dibutyl tin Oxide | 0.10 |
| O-Xylene | 7.82 |
| 3-(2,3-Epoxypropoxy) propyl trimethoxysilane | 1.08 |
| Dibutyl Tin dilaurate | 0.05 |
| Isophorone Diisocyanate | 2.00 |
| Mineral Turpentine Oil | 35.25 |
| Total | 100.00 |

Dehydrated castor oil Fatty acid, phthalic anhydride Pentaerythritol, benzoic acid, Dibutyl tin Oxide and O-xylene as reflux solvent were charged into the aforesaid reaction assembly and reaction mass was slowly heated to a temperature from 160° C. to 230° C. under azeotropic distillation with removal of water of reaction periodically till an acid number of <10 mg KOH/g and dilution viscosity (25° C. on Gardner scale) at 55% NVM in mineral turpentine oil of U-W is achieved. Once the desired constants are achieved, reaction mixture is cooled to 160-180° C. and reacted with 3-(2,3-Epoxypropoxy) propyl trimethoxysilane. Methanol and water produced during the reaction along with O-xylene were distilled off and reaction temperature was slowly raised to 200-220° C. and maintained for 2-3 hours till an acid number of <5 mg KOH/gm is achieved. The reaction mass was then further reacted with Isophorone Diisocyanate in presence of Dibutyl Tin dilaurate at 80-90 ° C. and maintained for 4-6 hours till constant viscosity is achieved. A clear silicone functional urethane alkyd solution is obtained with approx. 55% nonvolatile content, hydroxyl number (mg KOH/gm) 112.26 and viscosity of Z2-Z3 at 25° C. on Gardner scale. The resin was tested for accelerated stability at 55° C. for 15 days and no appreciable change in viscosity was observed.

The silicone functional urethane alkyd resin thus obtained was used to prepare white Paint at a PVC of 14-20% using Titanium dioxide, Zinc phosphate, dispersing agent, metallic driers, UV light absorbers, hindered amine light stabilizers and flow-levelling additives. The resulting paint was tested for drying, physical, mechanical, weathering and corrosion resistance performance and test results are summarized in the table.

### EXAMPLE 9

A silicone functional urethane alkyd resin was prepared by charging the following constituents into a four-necked reactor flask equipped with a temperature controller, heating mantle, nitrogen purger, overhead stirrer and Dean Stark assembly.

| Ingredients | Parts by Weight |
|---|---|
| Safflower Fatty acid | 41.05 |
| Phthalic anhydride | 12.39 |
| Pentaerythritol Nitration Grade | 11.89 |
| Trimethylol Propane | 2.23 |
| Dibutyl tin Oxide | 0.10 |
| O-Xylene | 3.56 |
| 3-(2,3-Epoxypropoxy)propyl] trimethoxysilane | 1.30 |
| Dibutyl Tin dilaurate | 0.05 |
| Isophorone Diisocyanate | 2.38 |
| Mineral Turpentine Oil | 25.05 |
| Total | 100.00 |

Safflower Fatty acid, phthalic anhydride Pentaerythritol, Trimethylol Propnane, benzoic acid, Dibutyl tin Oxide and O-xylene as reflux solvent were charged into the aforesaid reaction assembly and reaction mass was slowly heated to a temperature of up to 230° C. under azeotropic distillation with removal of water of reaction periodically till an acid number of <10 mg KOH/g and dilution viscosity (25° C. on Gardner scale) at 65% NVM in mineral turpentine oil of V-W is achieved. Once the desired constants are achieved, reaction mixture is cooled to 160-180° C. and reacted with 3-(2,3-Epoxypropoxy) propyl trimethoxysilane. Methanol and water produced during the reaction along with O-xylene were distilled off and reaction temperature was slowly raised to 200-220° C. and maintained for 2-3 hours till an acid number of <5 mg KOH/gm is achieved. The reaction mass was added with dibutyl tin dilaurate and further reacted with Isophorone Diisocyanate at 80-90° C. and maintained for 4-6 hours till constant viscosity is achieved. A clear silicone functional urethane alkyd solution is obtained with approx. 65% non volatile content, hydroxyl number (mg KOH/gm) 79.44 and viscosity of Z3-Z4 at 25° C. on Gardner scale. The resin was tested for accelerated stability at 55° C. for 15 days and no appreciable change in viscosity was observed.

The silicone functional urethane alkyd resin thus obtained was used to prepare a white Paint at a PVC of 14-20% using Titanium dioxide, Zinc phosphate, dispersing agent, metallic driers, UV light absorbers, hindered amine light stabilizers and flow-levelling additives. The resulting paint was tested for drying, physical, mechanical, weathering and corrosion resistance performance and test results are summarized in the table. The details pertaining to Coating compositions obtained from examples 1-9 are being described here in detail:

Coating Compositions Derived from Siliconized Urethane Alkyd:

Corrosion is commonly defined as a chemical or electrochemical reaction between a material, usually a metal, and its environment that produces a deterioration of the metal and its properties. corrosion may occur due to contact by atmospheric moisture, water, salinity, humidity or other corrosives normally present in rural, urban or industrial environments. Although coating composition of the present invention may be applied to any type of metallic substrate, it is especially suited for use on ferrous substrates. The present invention relates to the coating compositions for providing corrosion resistance to metallic objects/structures used in decorative as well as industrial segments.

In a special finding of the present invention, the suitably designed pigmented coating compositions when applied on mild steel substrate at dry film thickness of 75-90 microns in 3 or more coats with interval of 4-8 hours between coats provided corrosion resistance performance of 1000 hours or more without any sign of under film corrosion. Surprisingly the coating compositions based on the said silicone functionalized urethane alkyd also inhibited further corrosion when applied on properly cleaned corroded steel panels at dry film thickness of 75-90 microns in 3 or more coats for 800 hours or more as per ASTM B117 salt spray test.

The said functionalized urethane alkyd of the present invention provided high corrosion resistance and weathering performance while maintaining good gloss and mechanical properties like hardness, flexibility, impact and adhesion when used in a paint recipe involving Organic/inorganic pigment, anticorrosive pigments, metallic driers, UV light absorbers, hindered amine light stabilizers and other additives known in the art as per details given below:

Pigments provide color, opacity, Light fastness and barrier properties to the paint film. The most commonly used inorganic pigments are Titanium dioxide, carbon black, Iron oxides, zinc chromates, chromium oxides, cadmium sulphides, lithopone etc. Amongst the organic pigments, important ones are Azo metal complexes, phthalocyanine and anthraquinone derivatives, benzimidazolone, quinacridone, dioxazine, perylene, thioindigo, diketopyrollopyrrole etc.

In one of the embodiments of the present invention, the suitable anti-corrosive pigments include zinc phosphate, zinc oxide, calcium phosphate, strontium phosphosilicates, aluminium triphosphate, zinc molybdate, zinc phosphor molybdate, aluminium zinc phosphate, micaceous iron oxide, lead silico chromate, strontium chromate etc. and may form the part of coating composition in an amount of about 0.5 to 6% of the coating composition based on the total weight of the coating composition. Preferably, the anti-corrosive pigment content used was 0.5-3% based on the total weight of the coating composition. The higher quantities of anticorrosive pigments would improve corrosion resistance performance but significantly reduces the gloss. A preferred anti-corrosive pigment employed in the present coating composition is micronized zinc phosphate.

In one of the embodiments of present invention metallic driers were employed to accelerate the conversion of coating into cross linked dry film through auto oxidative polymerization. Driers are primarily metal soaps of organic acids. Some of the preferred drier combinations employed in context with the present invention are selected from the group comprising:
1) Cobalt Octoate: Acts as a “Surface Drier”. It is primarily an oxidation catalyst and an optimum quantity need to be used to avoid surface wrinkling
2) Borchi Oxy coat: It is a highly active Iron complex and recommended as an alternative to Cobalt based driers. However, in the present invention it has been used synergistically with cobalt to optimize cost and performance.
3) Calcium Octoate: It has both oxidizing and polymerizing properties and produce hard film.
4) Zirconium Octoate: Acts as an active cross-linking agent and improves hardness of dried film as well as its adhesions.
   However this invention is not limited to the aforesaid preferred metal salts and would also include all metal salts and their combination available under different trade names which could be used synergistically in the optimized ration to achieve desired coating performance.

In the paint compositions of the present invention, there may further be added various additives such as rheology modifiers, dispersing agent, antioxidants, anti-skinning and anti-settling agent etc. each in an adequate amount. A preferred solvent is MTO. The proportion of solvent may vary according to the desired consistency of the paint composition.

The present invention provides coating compositions which are meant for Top coat/self-priming enamel/under coat/primer for various ferrous, non-ferrous and chemical treated substrates such as degreased, iron/zinc phosphated etc. and may be easily applied by conventional application systems such as brushing, roller, spraying, sprinkling, flow coating, dipping, and the like. The DFT of the coating is preferably 75-90 microns in 3 or more coats wherein time interval between coats is 4-8 hours.

According to a further aspect of the present invention a test metal panel (cold rolled mild steel) coated with a control composition and a composition as per the current invention were subjected to various tests after 7 days of application to evaluate the coated film in respect of flexibility, impact resistance, scratch hardness, 1 mm cross cut adhesion and resistance to salt spray and weathering. The flexibility of the coatings was tested by conducting a Mandrel bend test (ASTM D 522). Scratch hardness of the coating was tested using Sheen make automatic scratch tester Ref. No. 705 with 1 mm tungsten carbide tip. The 1 mm cross-cut adhesion test was carried out according to ASTM D 3359. Impact Resistance of coating was tested using Falling-Ball Method (65±0.2 cm height×15.9±0.08 mm diameter×908±1 gm load).

The salt spray resistance of the coating was tested according to ASTM B117.The appearance of corrosion product was evaluated periodically, and test duration depended on the corrosion resistance of the coating; the more corrosion resistant coating, longer the period in testing without showing signs of corrosion. The weathering resistance was tested as per QUV 313 with exposure conditions as condensation 45±1° C./4 hrs, UV 50±1° C./4 hrs at 0.55±0.01 watts/m²/nm irradiance level as per ASTM G154.

The coating compositions prepared using siliconized urethane alkyd of the present invention tested for drying, physical, mechanical, weathering and corrosion resistance performance as stated above, and test results are summarized in the following table.

TABLE
Coating Composition Test Results

| Coating | | | | | | | | | |
|---|---|---|---|---|---|---|---|---|---|
| composition | | | | | | | | | |
| with Resin | Example | Example | Example | Example | Example | Example | Example | Example | Example |
| from | 1 | 2 | 3 | 4 | 5 | 6 | 7 | 8 | 9 |
| DFT (microns) | 77 | 72 | 76 | 77 | 78 | 70 | 75 | 76 | 75 |
| Surface dry time | 85 | 90 | 115 | 80 | 85 | 90 | 80 | 80 | 120 |
| (min)-IS 101 | | | | | | | | | |
| Tack free time | 4 | 4 | 4.5 | 3.5 | 4 | 4 | 3.5 | 3 | 4.5 |
| (hours)-IS 101 | | | | | | | | | |
| Hard dry time | 9 | 10 | 16 | 10 | 9 | 9 | 7 | 7 | 12 |
| (hours)-IS 101 | | | | | | | | | |
| Scratch | 1000 | 1100 | 1100 | 1000 | 1100 | 1000 | 1200 | 1200 | 1100 |
| hardness after | | | | | | | | | |
| 48 h (g) [IS 101] | | | | | | | | | |
| Flexibility-¼ | Passes | Passes | Passes | Passes | Passes | Passes | Passes | Passes | Passes |
| inch mandrel | | | | | | | | | |
| (IS 101) | | | | | | | | | |
| Impact | Passes | Passes | Passes | Passes | Passes | Passes | Passes | Passes | Passes |
| Resistance (1 Kg | | | | | | | | | |
| Front & Reverse | | | | | | | | | |
| (ISO 6172) | | | | | | | | | |
| Cross Cut | 5B | 5B | 5B | 5B | 5B | 5B | 5B | 5B | 5B |
| Adhesion | | | | | | | | | |
| (ASTM D | | | | | | | | | |
| 359B) | | | | | | | | | |
| Salt Spray Test | Passes | Passes | Passes | Passes | Passes | Passes | Passes | Passes | Passes |
| (Hours) | 600 | 550 | 400 | 500 | 1000 | 1000 | 1200 | 1200 | 1100 |
| (ASTM B117) | | | | | | | | | |
| At DFT 75-90 | | | | | | | | | |
| micron/3 coats | | | | | | | | | |
| (no under film | | | | | | | | | |
| corrosion) | | | | | | | | | |
| Gloss at 20° | 75 | 72 | 77 | 75 | 68 | 70 | 72 | 74 | 78 |
| QUB 313 Gloss | 18 | 22 | 15 | 18 | 29 | 27 | 32 | 35 | 30 |
| Retention (%) | | | | | | | | | |
| after 500 hrs | | | | | | | | | |
| Non Yellowing | Inferior | Good | Good | Poor | Good | Good | Good | Good | Good |
| after 500 hrs in | | | | | | | | | |
| QUV313, visual | | | | | | | | | |

It is thus possible by way of the present advancement to provide for a polymeric binder i.e. siliconized urethane alkyd suitable for ready to use single component air drying Top Coat/self-priming weatherable glossy enamel for mild steel substrates for low to high corrosion zones as validated through accelerated weathering in QUV 313 and accelerated corrosion resistance performance through ASTM B 117 salt fog test. Apart from excellent corrosion and weathering resistance, the said binder provided good gloss and mechanical properties like hardness, flexibility, impact and adhesion when used in a paint recipe involving Organic/inorganic pigment, anticorrosive pigments, metallic driers, UV light absorbers, hindered amine light stabilizers and other additives known in the art.

Surprisingly the coating compositions as stated above based on siliconized urethane alkyd binder of the present invention inhibited further corrosion to corroded steel when panels having 75-90 micron dry film thickness were subjected to salt spray resistance as per ASTM B 117 and passed for 1000 hours without any sign of loss of adhesion.

The formulation and process of manufacture of said siliconized urethane alkyd resin is selective favoring grafting of organosilanes followed by urethanization employing polyisocyanates and their derivatives in situ and in a manner to achieve a stable polymer when subjected to accelerated stability test at 55° C. for 15 days.

Most advantageously, the said siliconized urethane alkyd provided significantly superior corrosion and weathering resistance over conventionally available alkyds or known modified alkyds while also having mineral turpentine Oil (MTO) solubility that is widely preferred for air drying alkyds or coatings derived thereof. Such siliconized urethane alkyds find application in preparing anti-corrosive and weatherable coating compositions for protecting and maintaining the mild steel, corroded steel and other metallic substrates across the decorative and industrial segments. However, such coatings would also find application on other substrates including wood, glass and cementitious etc.

1. A siliconized urethane alkyd resin composition comprising:
a) a base alkyd resin component having hydroxyl number in the range of 50-150 mg KOH/gm, and acid number of 10 mg KOH/gm or less; a reaction product of reactive sub-components selected from the groups consisting of polyhydric alcohols, polybasic carboxylic acids and anhydrides thereof, hydroxycarboxylic acids, monofunctional carboxylic acids and vegetable oils or their fatty acids;
b) an organosilane component comprising one or more organosilanes having functional groups selected from one or more from the groups consisting of epoxide, alkoxy silane and silanol; and
c) an isocyanate component comprising one or more aliphatic, cycloaliphatic and aromatic isocyanate compounds having isocyanate functionality of 1 or more, wherein the isocyanate component consumes 40 to 70% of the initial OH number of above component.

2. The siliconized urethane alkyd resin as claimed in claim 1, wherein base alkyd component comprises of:
a) vegetable Oils or their fatty acids having Iodine number of 120-170 gm I2/100 g and are selected from Soya bean Oil, Sunflower Oil, dehydrated castor Oil, Safflower Oil, Tobacco seed Oil, Tung oil, Linseed Oil, Rubber seed Oil, Niger Seed Oil, Perilla oil, Hemp seed Oil, Tall Oil and like or a mixture thereof, and the amount of such oils/fatty acids varies from 25-80% based on Alkyd resin solids;
b) polyhydric alcohols selected from trimethyl pentanediol, diethylene glycol, neopentyl glycol, glycerol, pentaerythritol, trimethylolethane, trimethylol propane, methane propane diol, butyl ethyl propane diol, cyclohexane dimethylol; 1,6 hexane diol; 1,4 butane diol, sorbitol, dimethylol propionic acid and like or a mixture thereof, the amount of such polyols varies from 8-35% based on alkyd resin solids;
c) polybasic acids or acid anhydrides selected from isophthalic acid, terephthalic acid, phthalic anhydride, trimellitic anhydride; 1, 4 cyclohexane dicarboxylic acid; 1,2 cyclohexane dicarboxylic acid anhydride, maleopimaric acid, dimer fatty acid and any other aliphatic, aromatic or cycloaliphatic carboxylic acids/acid anhydride or a combination thereof. The amount of such polybasic acids or their anhydride varies form 8-35% of alkyd resin solids;
d) mono functional carboxylic acid is selected from benzoic acid, tertiary butyl benzoic acid, abietic acid (Rosin), cyclohexane carboxylic acid or similar as chain terminator. The amount of such mono carboxylic acid varies from 0-15% of base alkyd composition;
e) Catalyst for the synthesis of base alkyd is selected from dibutyl tin oxide, Lithium hydroxide, Lithium/tin salts of fatty acids/carboxylic acids and other metal salts or their oxides known for esterification and transesterification at dosage of 0-0.5%;
f) Reflux solvent to facilitate azeotropic distillation for the removal of water of reaction during the synthesis of base alkyd are selected from chemically inert functional groups like hydrocarbon/ketonic or similar which are non-reactive to the alkyd ingredients or alkyd itself. Such reflux solvents include isomers of xylene or their mixture, methyl n-amyl ketone or similar and their amount varies from 1-7%.

3. The siliconized urethane alkyd resin as recited in claim 1, wherein the organosilane component comprises:
a) an epoxide functional alkyl alkoxy silane and is incorporated at 0.5-5 wt % of base alkyd resin solids and are selected from [3-(2,3-Epoxypropoxy)propyl]trimethoxysilane]; [3,4 epoxycyclohexyl trimethoxy silane] or similar epoxy alkyl alkoxy silane suitable to react with carboxylic and hydroxyl functionality of alkyd resin; and/or
b) silanol-functional silicone resin and is incorporated at 2-20 wt % of base alkyd resin solids and are selected from silanol functional silicone oligomers available under different trade names such as Xiameter RSN Z 6018, Silrez SY 300, Silrez IC 368 and Baysilone AI TP 3653 or similar.

4. The siliconized urethane alkyd resin as recited in claim 1, wherein
a) the aliphatic, cycloaliphatic and aromatic mono/polyisocyanate components incorporated at 1-10% on siliconized alkyd solids and are selected from isophorone diisocyanate, hexamethylene diisocyanate, toluene diisocyanate, diphenyl methane diisocyanate and similar or their derivatives;
b) the catalyst for above said reaction is incorporated at 0-0.5% as metal content on resin solids and selected from the compounds of metal salts or esters of tin, Zinc, Zirconium, calcium, lithium etc. such as dibutyl tin dilaurate, zinc octoate, zirconium octoate and like.

5. A process for synthesizing siliconized urethane alkyd resin composition comprising the steps of:
a) reacting one or more polyhydric alcohols with one or more polybasic acids/acid anhydrides, hydroxycarboxylic acids and monofunctional carboxylic acids along with oils/fatty acids in presence of a catalyst and reflux solvent at a reaction temperature of 170-250° C. till acid number of 10 mg KOH/gm or less is achieved, to produce the base alkyd resin component with OH number in the range of 50-150 mg KOH/gm;
b) heating said base alkyd component with organosilane component to a temperature range of 130-220° C. till an acid number of 70 -30% of initial base alkyd acid number is achieved, followed by distilling out reaction condensates and diluting to 40-90% non-volatiles with mineral turpentine oil or other aliphatic/aromatic hydrocarbons to deliver a siliconized alkyd; and
c) reacting said siliconized alkyd through its free hydroxyls with any one of aliphatic, cycloaliphatic and aromatic polyisocyanates or their derivatives at a temperature of 50-130° C., in presence of a catalyst providing siliconized urethane alkyds having nonvolatile content of 40-90% and all the reactions take place in situ in a single pot.

6. The process of synthesizing siliconized urethane alkyd as claimed in claim 5, wherein ingredients in each step essentially consist of:
a) base alkyd component obtained by condensing 25-80% vegetable Oils or their fatty acids having Iodine number of 120-170 (gm I₂/100 gm) with 8-35% Polyhydric alcohols, 8-35% Poly carboxylic acids/acid anhydride, 0-15% mono carboxylic acid, 0-0.5% esterification catalyst and 1-6% reflux solvent upon heating to a temperature of 170-250° C. till acid number of <10 mg KOH/gm and desired viscosity is achieved,
b) said base alkyd component 80-99.5% is reacted with i) 0.5-10% epoxy alkyl alkoxy silane and/or with ii) 2-20% of silanol functional silicone resin intermediate at 130-220° C. and processed till an acid number of <5 mg KOH/gm and desired viscosity is achieved followed by distillation of reaction condensate and dilution with aliphatic/aromatic hydrocarbon solvents to deliver siliconized alkyd having non-volatile content of 40-90%,
c) said Siliconized alkyd 90-99% is reacted with any one of the aliphatic, cycloaliphatic and aromatic polyisocyanates or their derivatives 1-10% at a temperature of 50-130° C. till constant viscosity is achieved providing siliconized urethane alkyd having nonvolatile content of 40-90%.

7. The process of synthesizing siliconized urethane alkyd as claimed in claim 6, wherein the reaction for producing the base alkyd component is performed in presence of a catalyst selected from the group consisting of metal hydroxide, oxide and carboxylate ester.

8. The process of synthesizing siliconized urethane alkyd as claimed in claim 7, wherein the process employs one or more non-reactive solvent for dilution selected from isomers of xylene, Mineral turpentine Oil and similar aliphatic/aromatic hydrocarbons or mixtures thereof.

9. The process of synthesizing siliconized urethane alkyd as claimed in claim 6, wherein the step of urethanization of the siliconized alkyd is performed in presence of a catalyst selected from the group consisting of metal hydroxide, oxide and carboxylate ester, used at 0-0.5% as metal content on resin solids.

10. A method of producing air drying single component corrosion and weather resistant coating compositions from the siliconized urethane alkyd comprising:
a) incorporating said siliconized urethane alkyd with other coating ingredients selected from the group consisting of Inorganic pigments, organic pigments, anticorrosive pigments, dispersing agents, rheological additive and allowing then to disperse in a milling equipment in presence of grinding media to obtain a mill base having finish 7 on Hegmann Gauge;
b) adding remaining ingredients selected from metallic driers, UV light absorbers, hindered amine light stabilizers, anti-skin agent, additives and thinning solvents to the said mill base and allow the coating composition to mature for 16-24 hours and adjust to desired viscosity and solids;
c) applying said coating composition on a substrate wherein the substrate is selected from a group consisting of mild steel, suitably cleaned corroded steel, other metals and their alloys and glass, wood, cementitious.

11. The method as claimed in claim 10, wherein the coating compositions are produced by using combination of metal salts of Cobalt, Zirconium, Calcium and Iron complex (Borchi Oxy Coat) or similar metal salts as driers to catalyze autoxidative cross-linking through double bonds imparting improved drying and hardness development thereby faster recoat time of about 4-8 hours to complete the painting in a shorter period.

12. The method as claimed in claim 10, wherein the coating compositions comprising of Siliconized urethane alkyd to provide superior adhesion without the need of incorporating organosilane or any other adhesion promoter into the said coating compositions.

13. The method as claimed in claim 10, wherein the coating compositions having air drying, corrosion and weather resistant coating consisting of siliconized urethane alkyd as a polymeric binder in combination with coating ingredients suitable for “one pack” self-priming enamels, top coats, under coats and primer for a ready to use composition for application on variety of substrates.

14. The method as claimed in claim 10, wherein is adaptable in application process selected from brush, spray, roller, ragging and draw dawn to deposit a dry film thickness in the range of 75-90 microns in 3 or more coats with time interval of about 4-8 hours between the coats depending on the ambient temperature and humidity levels of the surroundings at the time of painting.

15. The method as claimed in claim 10, wherein the coating compositions provide aesthetics and protection to variety of substrates in a single component ready to use air drying paint.

16. The method as claimed in claim 10, wherein the coating compositions comprising of siliconized urethane alkyd provide single component oxidative crosslinking through air along with excellent solubility in an economical and safer Mineral Turpentine Oil or similar hydrocarbon solvent.

17. The method as claimed in claim 10, wherein the coating compositions wherein the grafting of organosilane into alkyd back bone followed by urethanization resulted into siloxane and urethane linkages in the siliconized urethane alkyd as claimed in any one of the preceding claims thereby providing superior mechanical, weathering and corrosion resistant performance to the coatings.

18. The method as claimed in claim 10, wherein the coating compositions comprising of said siliconized urethane alkyd in combination with other coating ingredients provide corrosion protection in different geographical and climatic conditions including in coastal, noncoastal, rural and urban areas.

19. The method as claimed in claim 10, wherein the coating compositions provide high gloss, corrosion resistance, mechanical properties and weathering performance especially in respect of gloss retention and non-yellowing.

20. The method as claimed in claim 10, wherein the coating compositions when applied at dry film thickness of 75-90 microns in 3 or more coats provide salt spray resistance of 1000 hours or more as per ASTM B 117 without any sign of under film corrosion.

21. The method as claimed in claim 10, wherein the coating compositions inhibited further corrosion when applied at dry film thickness of 75-90 microns in 3 or more coats on hand tool cleaned corroded mild steel substrates and provided protection for 1000 hours or more as per ASTM B 117 Salt spray test without any sign of loss of adhesion of the film.

22. The method as claimed in claim 10, wherein a self-priming enamel and top coat based on coating compositions provide 25-35% gloss of the original gloss of the panel after 500 hours exposure test as per QUV 313 with exposure conditions as condensation 45±1° C./4 hrs, UV 50±1° C./4 hrs at 0.55±0.01 watts/m²/nm irradiance level as per ASTM G154.
